(19) United States
(12) Patent Application Publication
(10) Pub. No.: US 2015/0199335 A1
(43) Pub. Date: Jul. 16, 2015

(54) METHOD AND APPARATUS FOR REPRESENTING USER LANGUAGE CHARACTERISTICS IN MPEG USER DESCRIPTION SYSTEM

(71) Applicant: Electronics and Telecommunications Research Institute, Daejeon (KR)

(72) Inventors: Mi Ran CHOI, Daejeon (KR); Hyun Ki KIM, Daejeon (KR); Pum Mo RYU, Daejeon (KR); Yong Jin BAE, Daejeon (KR); Hyo Jung OH, Daejeon (KR); Yeo Chan YOON, Gyeonggi-Do (KR); Chung Hee LEE, Daejeon (KR); Soo Jong LIM, Daejeon (KR); Myung Gil JANG, Daejeon (KR); Yo Han JO, Daejeon (KR); Yoon Jae CHOI, Daejeon (KR); Jeong HEO, Daejeon (KR)

(21) Appl. No.: 14/592,482

(22) Filed: Jan. 8, 2015

(30) Foreign Application Priority Data
Jan. 10, 2014 (KR) 10-2014-0003577
Dec. 18, 2014 (KR) 10-2014-0182991

(51) Int. Cl. G06F 17/28

(52) U.S. Cl. CPC G06F 17/28

(57) ABSTRACT

Disclosed is a method of representing user language characteristics in a MPEG user description (MPEG-UD) system including receiving a request for a user description (UD) of the user language characteristics from a recommendation engine, calling the UD of the user language characteristics from a UD database, and transmitting the called UD of the user language characteristics to the recommendation engine.

### CROSS-REFERENCE TO RELATED APPLICATION

The present application claims priority to and the benefit of Korean patent application numbers 10-2014-0003577 filed on Jan. 10, 2014 and 10-2014-0182991 filed on Dec. 18, 2014, the entire disclosures of each of which are incorporated herein by reference.

### BACKGROUND

1. Field of Invention

The present invention relates to a method and apparatus for representing user language characteristics in MPEG user description (MPEG-UD).

2. Description of Related Art

Recently, various services using big data have been introduced. The services urge users to make many selections. To help the users make the selections, a recommendation system may be used.

MPEG User Description (MPEG-UD) is being developed for a system for providing a better recommendation such that a user may make an easy and convenient selection by defining user information, context information, and a standard between several recommendation systems, which are used in a recommendation system.

In the current era of globalization, there is a need for a language service for users who use various languages in various fields. For example, exquisite translation techniques are needed to provide real life content such as IPTV content to users who use various languages in natural language forms.

### SUMMARY

The present invention is directed to a language service using a language-related user description (UD) in MPEG-UD.

One aspect of the present invention provides a method of representing user language characteristics in a MPEG user description (MPEG-UD) system, the method including: receiving a request for a user description (UD) of the user language characteristics from a recommendation engine; calling the UD of the user language characteristics from a UD database; and transmitting the called UD of the user language characteristics to the recommendation engine.

Another aspect of the present invention provides an apparatus for representing user language characteristics in an MPEG user description (MPEG-UD) system, the apparatus including: a user description (UD) manager configured to manage a user description (UD) that indicates static and dynamic information of a user; a context description (CD) manager configured to manage a context description (CD) that indicates context state information; a service description (SD) manager configured to manage a service description (SD) that indicates service information provided by an application; and a recommendation engine configured to, when a user request is received through the application, receive the UD, the CD, and the SD from the UD manager, the CD manager, and the SD manager, respectively, generate a recommendation description (RD) that indicates recommendation information based on the received UD, CD, and SD, and deliver the generated RD to the application, in which when a language service is needed for a service that is requested by the application, the recommendation engine receives a UD of user language characteristics from the UD manager and generates an RD indicating recommendation information for the language service based on the UD of the user language characteristics.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram showing an MPEG-UD system according to an embodiment of the present invention;

FIG. 2 is a block diagram showing an apparatus for representing user language characteristics in an MPEG-UD system according to an embodiment of the present invention;

FIG. 3 is a flowchart showing a method of representing user language characteristics in an MPEG-UD system according to an embodiment of the present invention;

FIG. 4 is a view illustrating syntax of user language characteristics according to an embodiment of the present invention;

FIG. 5 is a view illustrating semantics of user language characteristics according to an embodiment of the present invention;

FIG. 6 is a view illustrating syntax of user information according to an embodiment of the present invention;

FIG. 7 is a view illustrating semantics of user information according to an embodiment of the present invention;

FIG. 8 is a view illustrating syntax of available language name information and language command information according to an embodiment of the present invention;

FIG. 9 is a view illustrating semantics of available language name information and language command information according to an embodiment of the present invention;

FIG. 10 is a view illustrating syntax of authorized language test record information according to an embodiment of the present invention;

FIG. 11 is a view illustrating semantics of authorized language test record information according to an embodiment of the present invention;

FIG. 12 is a view illustrating syntax of user preference information according to an embodiment of the present invention;

FIG. 13 is a view illustrating semantics of user preference information according to an embodiment of the present invention;

FIG. 14 is a view illustrating syntax of translation preference information according to an embodiment of the present invention; and

FIG. 15 is a view illustrating semantics of translation preference information according to an embodiment of the present invention.

### DETAILED DESCRIPTION

Advantages and features of the present invention, and implementation methods thereof will be clarified through the following embodiments described with reference to the accompanying drawings. The present invention may, however, be embodied in different forms and should not be construed as limited to the embodiments set forth herein. Hereinafter, preferred embodiments of the present invention will be described in detail such that a person skilled in the art may carry out the technical idea of the present invention easily.

In this disclosure below, when one part (or element, device, etc.) is referred to as being “connected” to another part (or element, device, etc.), it should be understood that the former can be “directly connected” to the latter, or “indirectly connected” to the latter via an intervening part (or element, device, etc.). Furthermore, when one part is referred to as “comprising (or including or having)” other elements, it should be understood that it can comprise (or include or have) only those elements, or other elements as well as those elements if there is no specific limitation indicated.

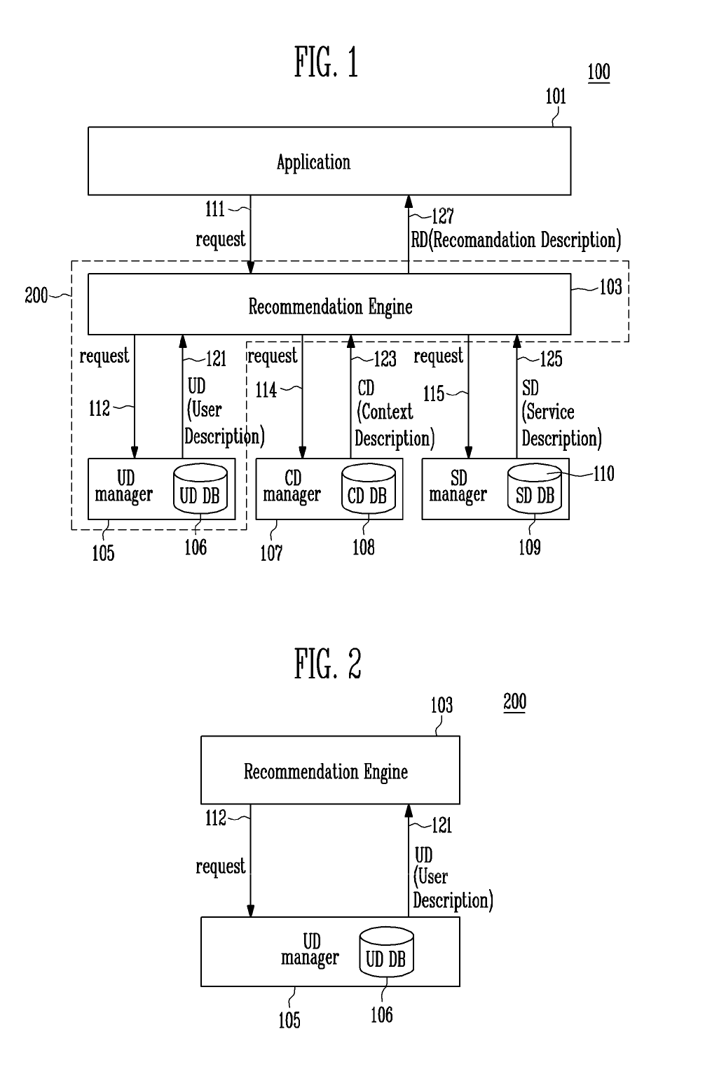

FIG. 1 is a block diagram showing an MPEG-UD system according to an embodiment of the present invention.

Referring to FIG. 1, an MPEG-UD system 100 according to an embodiment of the present invention includes an application 101, a recommendation engine 103, a user description (UD) manager 105, a context description (CD) manager 107, and a service description (SD) manager 109.

The application 101 is used to provide a service to a user directly. The user may enter desired information into the MPEG-UD system 100 through the application 101, and the MPEG-UD system 100 may provide a result to the user through the application 101. According to an embodiment of the present invention, the application 101 may receive a request from the user, deliver (111) the received request to the recommendation engine 103, and receive (127) a recommendation description (RD) from the recommendation engine 103.

The recommendation engine 103 may receive and combine a user description (UD), a context description (CD), and a service description (SD) to generate the RD. In this case, metadata on and logical associations between the UD, the CD, and the SD may be considered, and various ranges of RDs may be generated according to complexity and performance of the recommendation engine 103. According to an embodiment of the present invention, the recommendation engine 103 may receive a user request through the application 101, request (112,114,115) and receive (121, 123, 125) the UD, the CD, and the SD from the UD manager 105, the CD manager 107, and the SD manager 109, respectively, and generate the RD based on the received UD, CD, and SD to deliver (127) the RD to the application 101.

The UD manager 105 includes a user description (UD) database 106 and serves to generate and manage a user description (UD). The UD may indicate static and dynamic information of a user. The UD manager 105 according to an embodiment of the present invention may call the UD from the UD database 106 according to a request (112) of the recommendation engine 103 and transmit (121) the called UD to the recommendation engine 103.

FIG. 2 depicts in detail a process that considers user language characteristics. FIG. 2 shows a part surrounded by the dotted line of FIG. 1.

FIG. 2 is a block diagram showing an apparatus for representing user language characteristics in an MPEG-UD system according to an embodiment of the present invention.

In the MPEG-UD system 100 according to an embodiment of the present invention, an apparatus 200 for representing user language characteristics may include the recommendation engine 103 and the UD manager 105.

Upon receiving a request for a language service from the application 101, the recommendation engine 103 according to an embodiment of the present invention may receive a user description (UD) of user language characteristics from the UD manager 105 to generate a recommendation description (RD) that indicates recommendation information about a language service based on the UD of the user language characteristics.

Here, the language service may be needed when a language-related service such as voice recognition, voice synthesis, or language education is provided, or when a service is translated from a specific language to another language, for example, using e-learning, machine translation, or the like. According to an embodiment of the present invention, in any case, it is possible to provide a language service for users who use various languages in various fields.

The UD manager 105 according to an embodiment of the present invention may call the UD of the user language characteristics from the UD database 106 and transmit (121) the called UD to the recommendation engine 103 according to a request (112) of the recommendation engine 103.

Referring again to FIG. 1, the CD manager 107 includes a context description (CD) database 108 and serves to generate and manage a context description (CD). The CD may indicate context state information. The CD manager 107 according to an embodiment of the present invention may call the CD from the CD database 108 according to a request (114) of the recommendation engine 103 and transmit (123) the called CD to the recommendation engine 103.

The SD manager 109 includes a service description (SD) database 110 and serves to generate and manage a service description (SD). The SD may indicate service information that is provided by the application 101. The SD manager 109 according to an embodiment of the present invention may call the SD from the SD database 110 according to a request (115) of the recommendation engine 103 and transmit (125) the called SD to the recommendation engine 103.

FIG. 3 is a block diagram showing a method of representing user language characteristics in an MPEG-UD system according to an embodiment of the present invention.

Referring to FIG. 3, first, the UD manager 105 receives a user description (UD) of user language characteristics from the recommendation engine 103 in operation 310.

Subsequently, the UD manager 105 calls the UD of the user language characteristics from the UD database 106 in operation 320.

Next, the UD manager 105 may transmit the UD of the user language characteristics to the recommendation engine 103 in operation 330.

According to an embodiment of the present invention, in any case, it is possible to provide a language service for users who use various languages in various fields through the above-described process.

A method of representing user language characteristics more naturally and exquisitely will be described below.

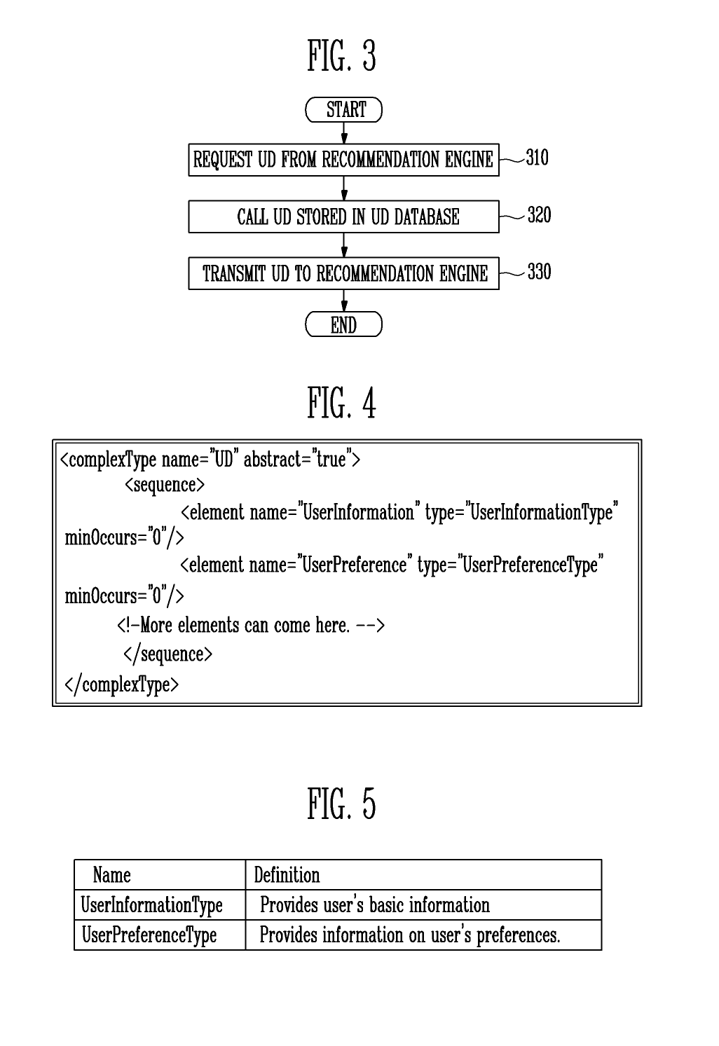

FIG. 4 is a view illustrating syntax of user language characteristics according to an embodiment of the present invention, and FIG. 5 is a view illustrating semantics of user language characteristics according to an embodiment of the present invention.

Referring to FIGS. 4 and 5, the user language characteristics may include at least one of user information and user preference information. Here, the user information may indicate basic information on a user, for example, an ID, a gender, a birthday, a hometown, a job, and a special field of the user that is associated with a service the user uses, which may be used to identify the user.

Furthermore, the user preference may indicate the user's taste.

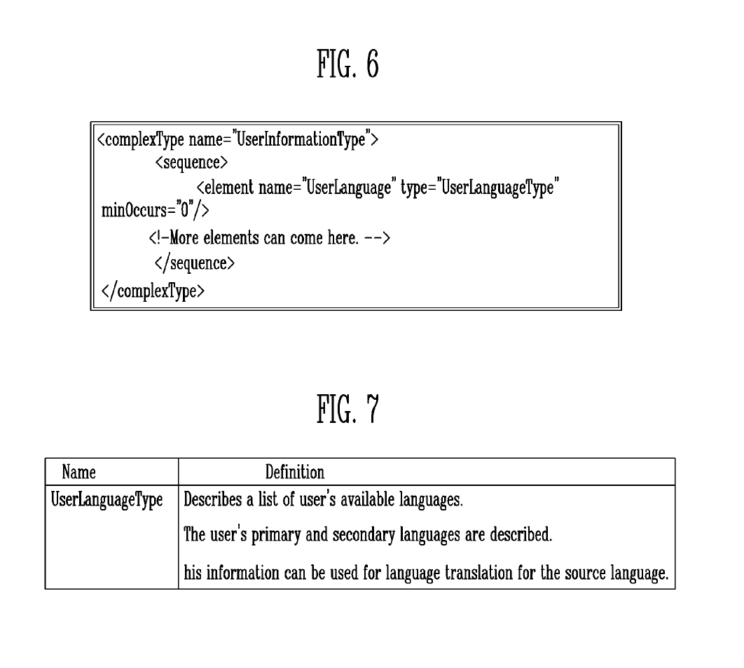

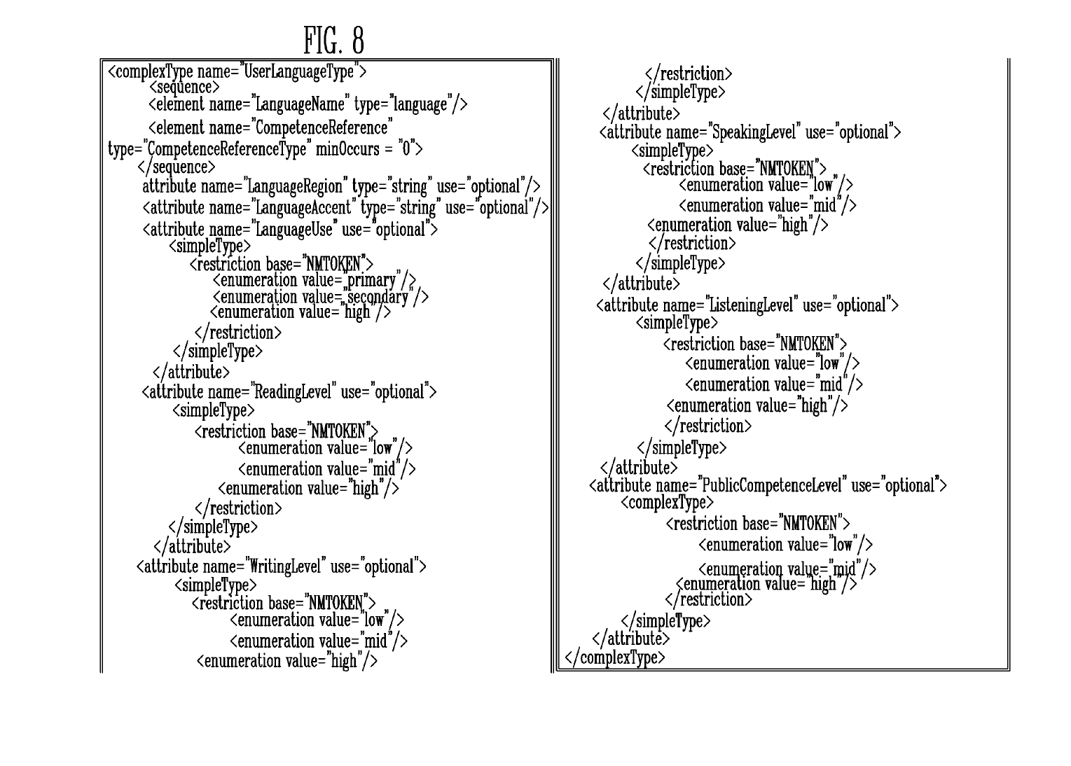

FIG. 6 is a view illustrating syntax of user information according to an embodiment of the present invention, and FIG. 7 is a view illustrating semantics of user information according to an embodiment of the present invention.

Referring to FIGS. 6 and 7, the user information may include user language information that is associated with the language service. Here, the user language information may indicate a language available to the user, a first language, which is a mother language, and a second language, which is a foreign language, and may be used as information for translation of a source language.

FIG. 8 is a view illustrating syntax of available language name information and language command information according to an embodiment of the present invention, and FIG. 9 is a view illustrating semantics of available language name information and language command information according to an embodiment of the present invention.

Referring to FIGS. 8 and 9, user language information may include at least one of the available language name information and the language command information.

Here, the user language information may indicate a language that is available to a user, and the available language name information may indicate a name of a language the user can speak. In this case, the user language information may include an attribute that indicates at least one of a region where the language is used, accents of the language, and whether the language is a first language being a mother language or a second language being a foreign language.

The language command information may indicate a degree of the command of the language. In this case, the user language information may include an attribute that indicates at least one of a reading level, a writing level, a speaking level, and a listening level as high, medium, or low. In this case, the level is not limited to terms “high,” “medium,” and “low.” That is, various terms may be used to classify the level into three stages. For example, the level may be classified into beginning, intermediate, and advanced levels.

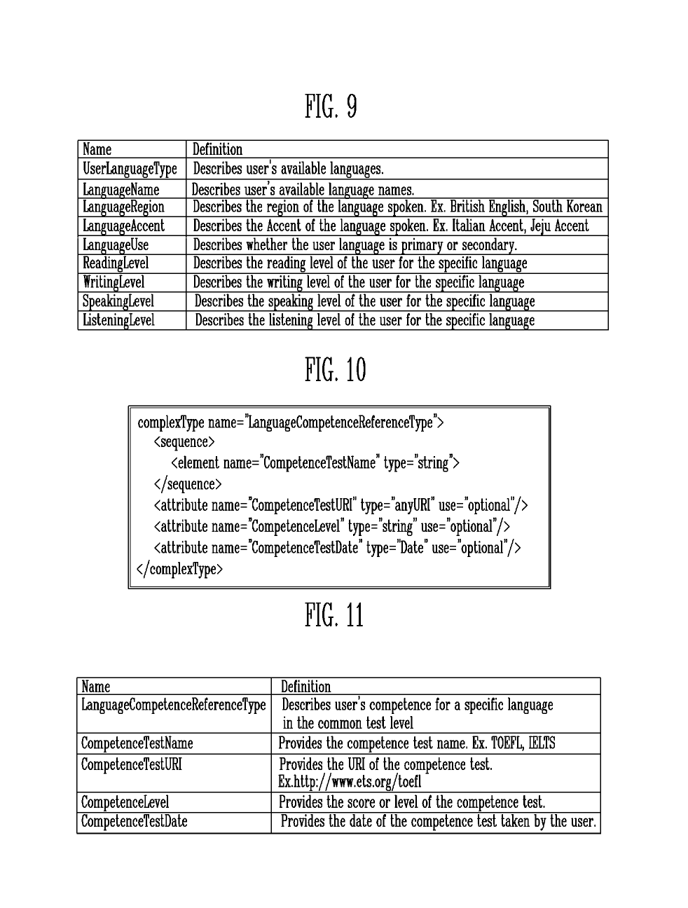

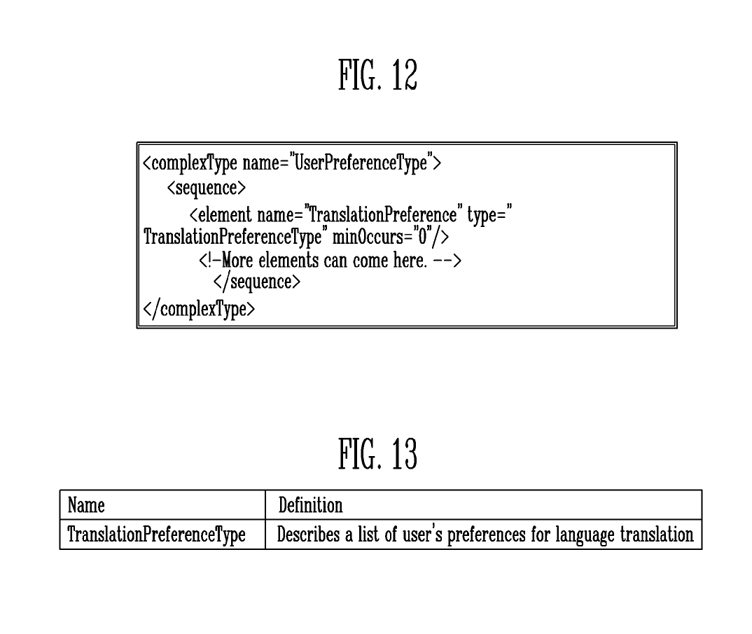

FIG. 10 is a view illustrating syntax of authorized language test record information according to an embodiment of the present invention, and FIG. 11 is a view illustrating semantics of authorized language test record information according to an embodiment of the present invention.

Referring to FIGS. 10 and 11, the language command information may include the authorized language test record information. Here, the authorized language test record information may indicate a result of a language test, of which objectivity is guaranteed, such as TOEFL™, IELTS™, and so on. In this case, the authorized language test record information may include an attribute that indicates at least one of a language type, a test name, a test uniform resource identifier (URI), a test level, and a test date.

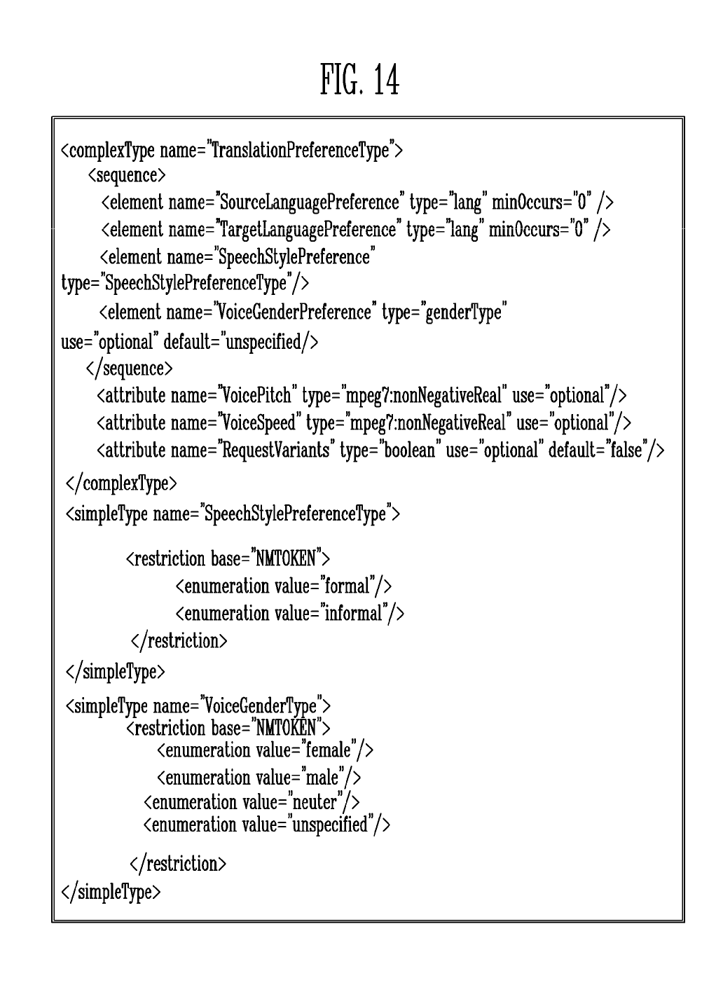

FIG. 12 is a view illustrating syntax of user preference information according to an embodiment of the present invention, and FIG. 13 is a view illustrating semantics of user preference information according to an embodiment of the present invention.

Referring to FIGS. 12 and 13, the user preference information may include translation preference information. In this case, the translation preference information may indicate the user's taste for translation.

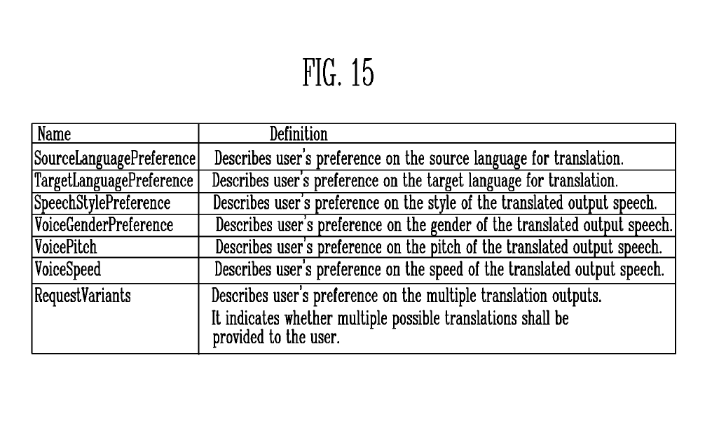

FIG. 14 is a view illustrating syntax of translation preference information according to an embodiment of the present invention, and FIG. 15 is a view illustrating semantics of translation preference information according to an embodiment of the present invention.

Referring to FIGS. 14 and 15, the translation information may include at least one of source language preference information, target language preference information, information for designating whether a representation format of the target language is formal or informal, and speaker gender information. The information for designating whether a representation format of the target language is formal or informal may indicate whether a formal language or informal language is preferred when there is an inflection such as change in suffix. In addition, the speaker gender information may indicate male, female, neuter, or unidentified gender, thus allowing a voice of a gender that is preferred by the user to be output.

Furthermore, the translation preference information includes an attribute that indicates at least one of a voice pitch, a voice speed, and a plurality of translations, thus allowing a result to be conveniently used at a pitch or speed that is preferred by the user.

The present invention may indicate in detail a method of representing user language characteristics and thus providing a natural and exquisite language service in the MPEG-UD.

In the drawings and specification, there have been disclosed typical exemplary embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method of representing user language characteristics in an MPEG user description (MPEG-UD) system, the method comprising:
receiving a request for a user description (UD) of the user language characteristics from a recommendation engine;
calling the UD of the user language characteristics from a UD database; and
transmitting the called UD of the user language characteristics to the recommendation engine.

2. The method of claim 1, wherein the user language characteristics include at least one of user information and user preference information.

3. The method of claim 2, wherein the user information includes user language information associated with a language service.

4. The method of claim 3, wherein the user language information includes at least one of available language name information and language command information.

5. The method of claim 3, wherein the user language information is used as information for translating a source language.

6. The method of claim 3, wherein the user language information includes an attribute that indicates at least one of a region where a language is used, accents of the language, and whether the language is a first language being a mother language or a second language being a foreign language.

7. The method of claim 3, wherein the user language information includes an attribute that indicates at least one of a reading level, a writing level, a speaking level, and a listening level as a beginning, intermediate, or advanced level.

8. The method of claim 3, wherein the language command information includes authorized language test record information.

9. The method of claim 8, wherein the authorized language test record information includes an attribute that indicates at least one of a language type, a test name, a test uniform resource identifier (URI), a test level, and a test date.

10. The method of claim 2, wherein the user preference information includes translation preference information.

11. The method of claim 10, wherein the translation preference information includes at least one of source language preference information, target language preference information, information for designating whether a representation format of the target language is formal or informal, and speaker gender information.

12. The method of claim 11, wherein the information for designating whether the representation format of the target language is formal or informal indicates a formal language or informal language.

13. The method of claim 11, wherein the speaker gender information indicates male, female, neuter, or unidentified gender.

14. The method of claim 11, wherein the translation preference information includes an attribute that indicates at least one of a voice pitch, a voice speed, and a plurality of translations.

15. An apparatus for representing user language characteristics in an MPEG user description (MPEG-UD) system, the apparatus comprising:
a user description (UD) manager configured to manage a user description (UD) that indicates static and dynamic information of a user;
a context description (CD) manager configured to manage a context description (CD) that indicates context state information;
a service description (SD) manager configured to manage a service description (SD) that indicates service information provided by an application; and
a recommendation engine configured to, when a user request is received through the application, receive the UD, the CD, and the SD from the UD manager, the CD manager, and the SD manager, respectively, generate a recommendation description (RD) that indicates recommendation information based on the received UD, CD, and SD, and deliver the generated RD to the application,
wherein when a language service is needed for a service that is requested by the application, the recommendation engine receives a UD of user language characteristics from the UD manager and generates an RD indicating recommendation information for the language service based on the UD of the user language characteristics.

16. The apparatus of claim 15, wherein the user language characteristics include at least one of user information and user preference information.

17. The apparatus of claim 16, wherein the user information includes user language information associated with a language service.

18. The apparatus of claim 16, wherein the user language information includes at least one of available language name information and language command information.

19. The apparatus of claim 16, wherein the user preference information includes translation preference information.

20. The apparatus of claim 19, wherein the translation preference information includes at least one of source language preference information, target language preference information, information for designating whether a representation format of the target language is formal or informal, and speaker gender information.
